(19) United States
(12) Patent Application Publication
(10) Pub. No.: US 2026/0017732 A1
(43) Pub. Date: Jan. 15, 2026

(54) SYSTEM AND METHOD FOR REAL-TIME POWER CONSUMPTION MANAGEMENT OF NON-CRITICAL DATA CENTERS

(71) Applicant: Flext Live, LLC, Houston, TX (US)

(72) Inventor: Mark Ruggles, Houston, TX (US)

(73) Assignee: Flext Live, LLC, Houston, TX (US)

(21) Appl. No.: 19/264,788

(22) Filed: Jul. 9, 2025

Related U.S. Application Data
(60) Provisional application No. 63/669,149, filed on Jul. 9, 2024.

(51) Int. Cl. G06Q 50/06; G06Q 30/0283

(52) U.S. Cl. CPC G06Q 50/06; G06Q 30/0283

(57) ABSTRACT

The present invention provides a system comprising a power grid operator, a power provider, one or more non-critical data centers configured to receive power from the power provider, and a computing platform in data communication with at least the power provider and the one or more non-critical data centers, wherein the computing platform is configured to at least: (1) receive real-time power consumption data from the one or more non-critical data centers; (2) receive real-time power pricing data from the power grid operator or the power provider; (3) automatically send a curtailment signal to each of the one or more non-critical data centers; and (4) automatically send an end curtailment signal to each of the one or more non-critical data centers. The one or more non-critical data centers may comprise at least one cryptocurrency mining data center, or, alternatively, may comprise at least one non-critical artificial intelligence data center.

### CROSS-REFERENCE TO RELATED APPLICATION

This application claims the benefit of U.S. Prov. App. No. 63/669,149 (filed Jul. 9, 2024), which is incorporated by reference herein in its entirety.

### BACKGROUND

Critical data centers are facilities designed to support essential business operations with high availability and reliability. These centers house the computing infrastructure, like servers and storage systems, that power vital applications and data processing for organizations where downtime can result in significant financial loss or operational disruption.

By contrast, non-critical data centers are facilities that house IT equipment supporting applications and services where downtime or interruptions are not as detrimental to business operations as they would be in a critical data center. These facilities often host applications and data that are not time-sensitive or essential for immediate business functions. These data centers primarily handle non-essential applications and services, meaning that a temporary outage or slowdown would not significantly impact core business operations. Non-critical data centers may operate at lower tier standards (e.g., Tier I or II) compared to critical data centers (e.g., Tier III or IV), meaning that they might have less redundancy and fault tolerance. Non-critical data centers might host applications like email systems, internal document storage, development and testing environments, or less time-sensitive data processing tasks.

In one specific example, artificial intelligence (“AI”) data centers can be either critical or non-critical, depending on the type of AI workloads they support and the business context. Non-critical AI data centers often handle tasks where uptime is less crucial or workloads can be delayed, such as model training environments (that can be paused/resumed), research and experimentation, non-production inference, batch analytics, and AI-based reports generated nightly or weekly. Even though non-critical, such AI services may also distributed across multiple redundant nodes to prevent job loss from hardware failure or downtime.

Cryptocurrency mining (“crypto mining”) is yet another example of a non-critical data center application. Crypto mining is the process of creating new cryptocurrency by solving extremely complicated math problems that verify transactions in the currency. When a cryptocurrency is successfully mined, the miner receives a predetermined amount of cryptocurrency. Bitcoin is one of the most popular types of cryptocurrencies, which are digital mediums of exchange that exist solely online. Bitcoin runs on a decentralized computer network or distributed ledger that tracks transactions in the cryptocurrency. When computers on the network verify and process transactions, new bitcoins are created, or mined. These networked computers, or miners, process the transaction in exchange for a payment in bitcoin. Bitcoin is powered by blockchain, which is the technology that powers many cryptocurrencies. A blockchain is a decentralized ledger of all the transactions across a network. Groups of approved transactions together form a block and are joined to create a chain. Bitcoin mining is the process of adding a block to the chain. In order to successfully add a block, bitcoin miners compete to solve extremely complex math problems that require the use of expensive computers and enormous amounts of electricity. The computer hardware required is known as application-specific integrated circuits, or ASICs. ASICs are often organized in non-critical crypto mining data centers, and consume huge amounts of electricity that serves to limit the profitability of miners.

It is well-known in the art that non-critical data centers can shut down or be throttled down to an idle state when power is expensive or constrained. This practice is part of energy-aware computing and cost-optimized infrastructure management, especially in crypto mining and redundant, non-critical AI operations. Electricity prices can spike due to, for example, demand surges, weather events, or grid constraints.

Data center operators with variable power pricing may choose to reduce computer loads during high-cost periods to avoid overspending. Similarly, power providers with fixed power pricing contracts with non-critical data centers may choose to curtail power to such operations during periods where power can be sold to the grid at a higher price. Similarly, grid operators/utilities may request load reductions by non-critical data centers during peak times, who would then earn incentives or avoid penalties. In these three scenarios, there still remains the problem of timing and coordination-monitoring real-time power pricing, quickly and efficiently reacting to signals indicating power curtailment, and effectuating said unscheduled curtailments in a timely manner that meets the goals of the non-critical data center operator, power provider, and/or grid operator. What is described herein is a computing platform and system for solving this problem.

### SUMMARY OF THE INVENTION

The present invention provides a system comprising a power grid operator, a power provider, one or more non-critical data centers configured to receive power from the power provider, and a computing platform in data communication with at least the power provider and the one or more non-critical data centers, wherein the computing platform is configured to at least: (1) receive real-time power consumption data from the one or more non-critical data centers; (2) receive real-time power pricing data from the power grid operator or the power provider; (3) send a curtailment signal to each of the one or more non-critical data centers; and (4) send an end curtailment signal to each of the one or more non-critical data centers. The one or more non-critical data centers may comprise at least one cryptocurrency mining data center, or, alternatively, may comprise at least one non-critical artificial intelligence data center.

In certain embodiments of the present invention, the curtailment signal may be automatically sent by the computing platform to each of the one or more non-critical data centers upon receipt by the computing platform of a bulk curtailment signal from the power provider. Alternatively, the curtailment signal may be automatically sent by the computing platform to each of the one or more non-critical data centers when the real-time power price is above a predetermined curtailment price. An end curtailment signal may be automatically sent by the computing platform to each of the one or more non-critical data centers upon receipt by the computing platform of a bulk end curtailment signal from the power provider. Alternatively, an end curtailment signal may be automatically sent by the computing platform to each of the one or more non-critical data centers when the real-time power price remains below a predetermined end curtailment price for a predetermined period of time.

In certain embodiments of the present invention, the power provider and at least one non-critical data center has a purchase power agreement (PPA) comprising a fixed contractual power price, wherein the PPA allows the power provider to curtail power to the at least one non-critical data center. Alternatively, the power provider and at least one non-critical data center has a purchase power agreement (PPA) comprising a variable power price, wherein the PPA allows the at least one data center to voluntarily curtail power.

In certain embodiments of the present invention, the computing platform comprises a primary database that receives external data and API data, and a time series database in data communication with the primary database that enables web-based access by registered users to user-specific timestamped API data. The web-based access may consist of a dashboard that provides, amongst other things, information such as real-time power consumption data, historical power consumption data, and data relevant to curtailment events. The registered users are selected from administrators and/or operators of the at least one non-critical data centers, administrators and/or operators of the computing platform, administrators and/or operators of the power provider, administrators and/or operators of the grid operator, as well as additional potential users such as energy traders and payment processors.

The computing platform of the present invention may be further configured to provide alerts to one or more of the grid operator, the power provider, and the one or more non-critical data centers under certain circumstances, such as, for example: (1) the real-time power price is above a predetermined curtailment price; (2) a curtailment signal is sent to the one or more non-critical data centers; and/or (3) an end curtailment signal is sent to the one or more non-critical data centers.

The computing platform of the present invention may be further configured to provide invoicing data to the power provider and/or the one or more non-critical data centers. The computing platform of the present invention may be further configured to provide energy consumption invoicing, including daily energy consumption invoicing, to at least one of the non-critical data centers and a third-party payment service provider via a secure API connectivity.

### DESCRIPTION OF FIGURES

The features and advantages of the present invention will be more clearly understood from the following description taken in conjunction with the accompanying drawings in which:

FIG. 1 depicts a block diagram for a first illustrative power control distribution system in accordance with certain teachings of the present invention.

FIG. 2 depicts a block diagram for a second illustrative power control distribution system in accordance with certain teachings of the present invention.

FIG. 3 depicts an illustrative data communication arrangement for the computing platform of the present invention.

FIG. 4a depicts a first illustrative dashboard showing real-time power consumption for a non-critical data center, in accordance with certain teachings of the present invention.

FIG. 4b depicts a second illustrative dashboard showing real-time power consumption for five non-critical data centers, in accordance with certain teachings of the present invention.

FIG. 5 depicts the power consumption for five non-critical data centers during a curtailment “event” lasting approximately 15 minutes, in accordance with certain teachings of the present invention.

### DETAILED DESCRIPTION OF THE INVENTION

The features and advantages of the present invention will be more clearly understood from the following description.

The present invention is directed to a computing platform, preferably a cloud-based computing platform, and system for (1) monitoring real-time energy consumption by one or more non-critical data centers; (2) monitoring real-time power pricing data provided by the grid operator and/or power provider; (3) automatically sending real-time operational alerts to the power provider and the one or more non-critical data centers; and (4) automatically sending and receiving real-time operational signals to and from the power provider and the one or more non-critical data centers. As such, the present invention enables the platform to serve as a 24/7 monitoring, signaling, and alerting tool, and further enables non-critical data centers to promote operational compliance to its contractual agreements, specifically power curtailment requirements due to a price spike caused by, for example, demand surges, weather events, or grid constraints. The computing platform of the present invention may collect both private and publicly available data on a continuous real-time basis and stores that data into a database or database system (such as PostgreSQL).

In a first embodiment of the present invention, the private and publicly available data comprises real-time operations data, including but not limited to, real-time energy consumption levels for the one or more non-critical date centers, real-time idle or curtailment levels, real-time estimated energy dollar expenditure levels, real-time compliance to one or more power purchase agreements (PPAs) and/or other agreements, and identification of operational errors and/or inefficiencies and resolution opportunities.

In a second embodiment of the present invention, the private and publicly available data comprises curtailment data, including but not limited to, real-time quantity of power that is available to be curtailed for economic reasons and/or grid stability, bulk curtailment signals from a grid operator/utility, individual curtailment signals to the one or more non-critical data centers, and curtailment signal history, acknowledgement, and/or compliance. In a preferred aspect of the computing platform of the present invention, the bulk curtailment signals from the power provider automatically triggers the individual curtailment signals to be sent to the one or more non-critical data centers, thereby providing 24-hour automatic curtailment control and maximum curtailment profit realization.

In a third embodiment of the present invention, the private and publicly available data comprises energy usage data, including but not limited to, real-time intra-day energy consumption levels (MWs) and associated energy costs, lease costs, and other costs incurred by the one or more non-critical data center operators; month-to-date energy consumption levels and associated energy costs, lease costs, and other costs incurred by the one or more non-critical data center operators; and month-to-date energy utilization levels relative to one or more power purchase agreements (PPAs) and/or other agreements.

In a fourth embodiment of the present invention, the private and publicly available data comprises automatic daily, weekly, and/or monthly invoicing data between one or more non-critical data center operators and one or more third party payment service providers via secure API connectivity, invoice audit data, real-time invoice status (which allows, for example, credit group managers to evaluate A/R risk), user definable alerting and signaling for invoice processing, and communications data with International Organization for Standardization (ISO) and/or Qualified Scheduling Entity (QSE) service providers to receive, calculate and display initial settlement data in real-time.

In a fifth embodiment of the present invention, the private and publicly available data comprises registered user data to limit access as necessary and maintain a secure cloud-based software platform. In a preferred aspect of the present invention, the computing platform is System and Organization Controls 1 (SOC 1) compliant, which is a financial reporting standard developed by the American Institute of Certified Public Accountants (AICPA) for evaluating how well a service organization's internal controls support the financial reporting of its clients, which is highly relevant for companies that handle or impact financial data for companies such as data centers and/or cloud providers. In another preferred aspect of the present invention, the computing platform is SOC 2 compliant, which is a security and privacy audit standard developed by the AICPA for technology and cloud-based service providers to demonstrate that they manage customer data securely and protect privacy.

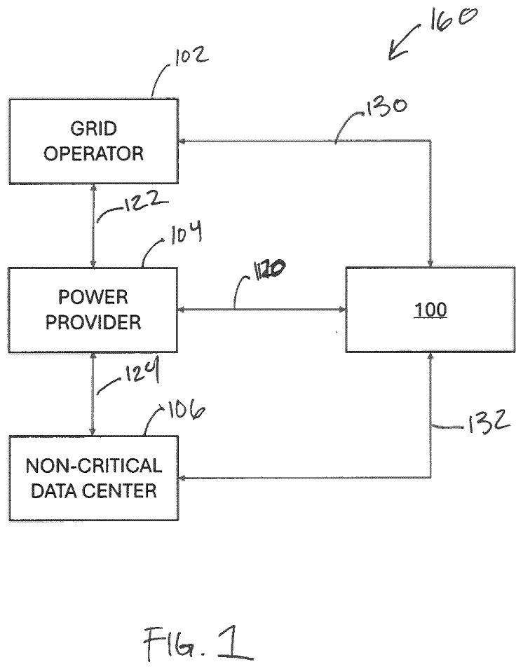

With reference to FIG. 1, the cloud-based computing platform 100 is shown in a power control distribution system 160 further including grid operator 102, power provider 104, and non-critical data center 106. System 160 represents one illustrative configuration for controlling the power consumption of the non-critical data center 106, but other configurations may include more or fewer components in other arrangements.

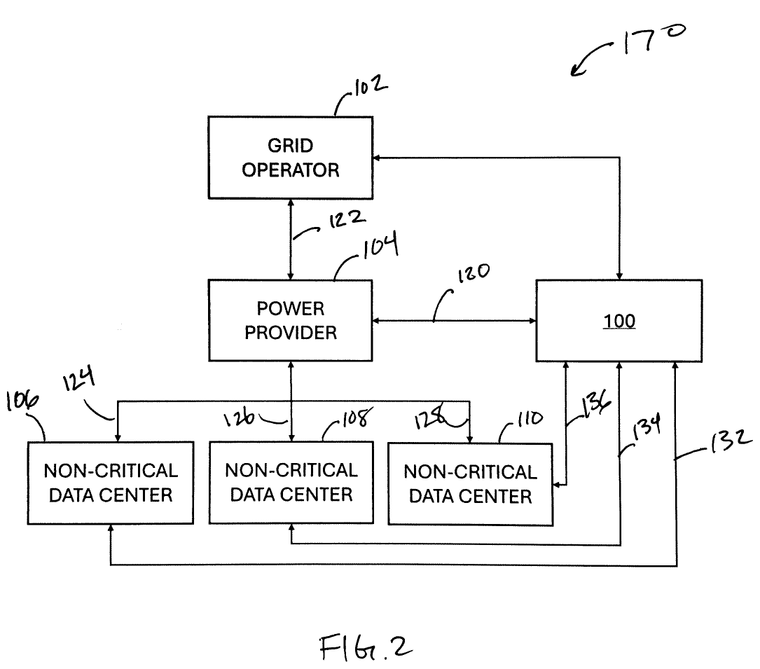

Similarly, in FIG. 2, the cloud-based computing platform 100 is shown in a power control distribution system 170 including grid operator 102, power provider 104, and non-critical data centers 106, 108, and 110. System 170 represents a second illustrative configuration for independently controlling the power consumption of the non-critical data centers 106, 108, and 110, but other configurations may include more or fewer components (including more or fewer non-critical data centers) in other arrangements.

Computing platform 100 may independently (or cooperatively with one or more of the grid operator 102 and/or the power provider 104) modulate power to the non-critical data centers 106, 108, and/or 110. During operations, power delivery to the non-critical data centers 106, 108, and/or 110 may be dynamically adjusted based on preset conditions or operational directives from grid operator 102 and/or power provider 104. The preset conditions may correspond to, for example, economic conditions such as power pricing. The dynamic power modulation may include, for example, throttling down power consumption and/or throttling up power consumption to the non-critical data centers 106, 108, and/or 110. Computing platform 100 may communicate with power provider 104 over a networked or other data connection 120, with grid operator 102 over a networked or other data connection 130, and with the non-critical data centers 106, 108, and/or 110 over a networked or other data connections 132, 134, and 136, respectively.

Grid operator 102 may include one or more computing systems that are configured to control various aspects of the power grid that receives power from power provider 104 and/or other power providers (not shown). Grid operator 102 may communicate with power provider 104 over a networked or other data connection 122, and with computer platform 100 over a networked or other data connection 130.

Power provider 104 may correspond to any type of grid-connected utility-scale power producer capable of supplying power to one or more loads, including but not limited to grid operator 102 and non-critical data centers 106, 108, and/or 110. In addition to power generation equipment, power provider 104 may include one or more control systems configured to control various aspects of power generation, transformation, and/or distribution. Power provider 104 may include one or more communication interfaces for communicating with computing platform 100, grid operator 102, and/or non-critical data centers 106, 108, and/or 110, one or more behind-the-meter interfaces, a grid interface, and one or more user interfaces. Power provider 104 may communicate with computer platform 100 over a networked or other data connection 120, with grid operator 102 over a networked or other data connection 122, and with the non-critical data centers 106, 108, and/or 110 over a networked or other data connections 132, 134, and 136, respectively.

Non-critical data centers 106, 108, and/or 110 may each include a power input system, a communication interface, a data center control system, a power distribution system, a climate control system, one or more computer systems, and a queue system connected by a communication bus. Non-critical data centers 106, 108, and/or 110 may include more or fewer components and may be combined or further divided into additional components. Each non-critical data center may have a different configuration when implemented based on a variety of factors that may influence its design, such as location and temperature of that the location, particular uses for the data center, source of power supplying the one or more computer systems within the each data center, design influences from the entity that implements each data center, and space available for each data center. The physical construction and layout of each data center can vary. In some instances, for example, each data center may utilize a metal container. In general, each data center may utilize some form of secure weatherproof housing designed to protect interior components from weather and intrusion. Within each data center, various internal components utilize power to perform some form of operations. A power input and distribution system is a module of each data center configured to receive external power (for example, from power provider 104 and/or the grid) and distribute the power to the different components. Each data center will also include a control system that provide directives to the one or more computing systems to change operations in some manner. For instance, the control system may cause one or more computer systems to operate at a different power consumption mode (e.g., a lower power mode or an idle mode). The control system may also be configured to analyze the one or more computer systems available when a new computational operation is assigned to the data center.

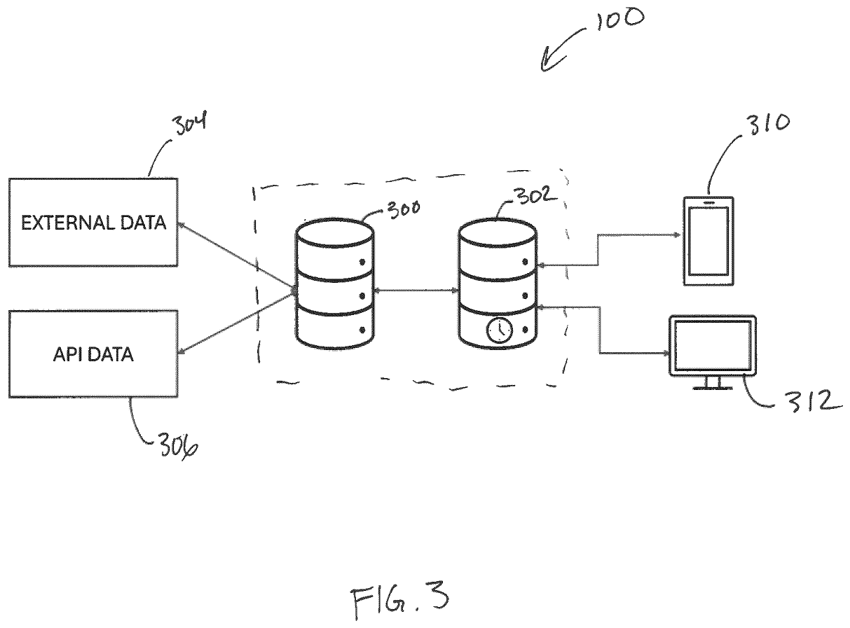

With reference to FIG. 3, computer platform 100 is represented by a primary database system 300, preferably PostgreSQL. Database system 300 sends and receives external data 304, including but not limited to: (1) power provider 104′s power pricing setpoint for curtailment; (2) grid operator 102′s real-time power pricing; (3) power provider 104′s PPA contractual terms for power pricing and curtailment with non-critical data centers 106, 108, and 110; and (4) meter data for each of non-critical data centers 106, 108, and 110. Database system 300 also sends and receives Application Programming Interface (API) data 306 with non-critical data centers 106, 108, and 110 (through data connections 132, 134, and 136), with power provider 104 (through data connection 120), and with grid operator 102 (through data connection 130). Database system 300 is also in communication with time series database 302, which is optimized for storing, querying, analyzing, and displaying sequences of the timestamped-API data 306. Time series database 302 is utilized for web-based access to timestamped-API data 306 by one or more registered users via either mobile application 310 or desktop application 312. Registered users may include, for example: (1) administrators and/or operators of non-critical data centers 106, 108, and 110; (2) administrators and/or operators computing platform 100; (3) administrators and/or operators of power provider 104; and (4) any other individuals granted access to timestamped-API data 306, such as grid operator 102, energy traders, payment processors, etc. In a preferred aspect of the present invention, each registered user may have access to specific information based on specific needs for that user, including but not limited to a custom dashboard view. For example, an administrator for power provider 104 may see power consumption on an aggregate basis (i.e., all data centers together), an administrator for computing platform 100 may have access to all data, and each individual data center administrator may only have access to its respective data.

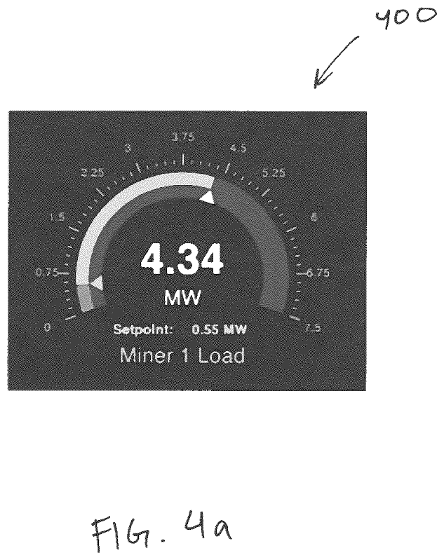

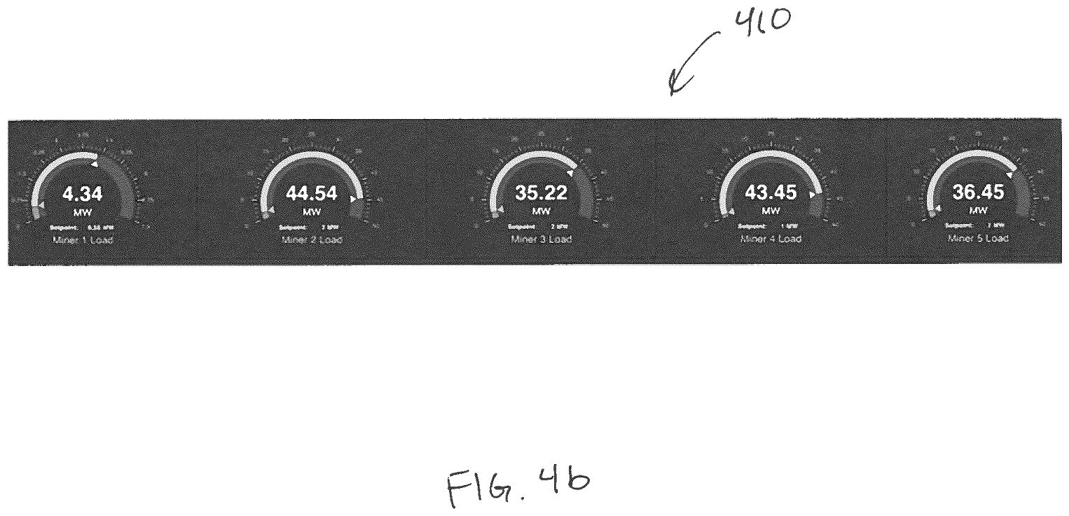

In a first illustrative preferred embodiment of the present invention, cloud-based computing platform 100 (as shown in FIG. 1) is connected to one crypto mining data center (“Miner 1”). With reference to FIG. 4a, a demonstrative dashboard 400 is depicted showing real-time power consumption (4.34 MW) for Miner 1, as well as a power curtailment setpoint (0.55 MW) communicated to Miner 1 by computing platform 100.

In a second illustrative embodiment of the present invention, cloud-based computing platform 100 (as shown in FIG. 2) is connected to five crypto mining data centers (“Miners 1-5”). With reference to FIG. 4b, a demonstrative dashboard 410 is depicted showing real-time power consumption (4.34 MW) and power curtailment setpoint (0.55 MW) for Miner 1, real-time power consumption (44.54 MW) and power curtailment setpoint (2 MW) for Miner 2, real-time power consumption (35.22 MW) and power curtailment setpoint (2 MW) for Miner 3, real-time power consumption (43.45 MW) and power curtailment setpoint (1 MW) for Miner 4, and real-time power consumption (36.45 MW) and power curtailment setpoint (2 MW) for Miner 5.

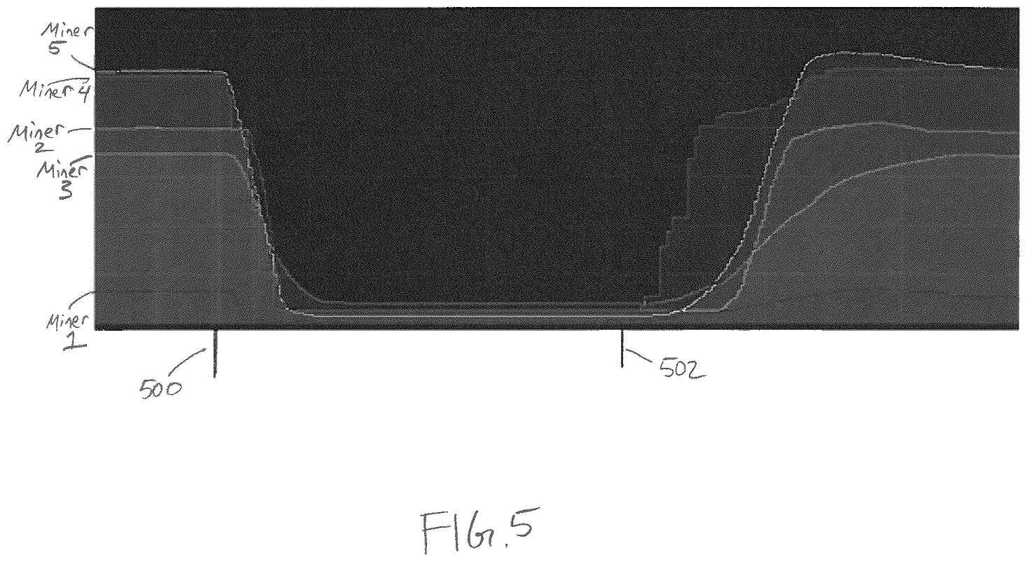

In a third illustrative embodiment of the present invention, with reference to FIG. 5, cloud-based computing platform 100 receives a “bulk” curtailment signal from power provider 104 at 9:15 am, requesting that the starting load of 196.6 MWs for Miners 1-5 be throttled down to 7.55 MW:

| ID # | Event Received | Curtail | Set Point | Starting Load |
|---|---|---|---|---|
| 1140 | Jun. 30, 2025 9:15 | YES | 7.55 | 196.60 |

Cloud-based computing platform 100 then calculates and signals individual power curtailment setpoints to each of Miners 1-5 in real-time, along with any applicable ramp rate (such as a total 99 MW/minute change, for grid stability purposes). In an alternative embodiment of the present invention, computing platform 100 automatically detects that a specific power pricing threshold is exceeded, or a specific power pricing threshold is exceeded for a minimum threshold period of time, and then calculates and signals an allocated power curtailment setpoint 500 to each of Miners 1-5 in real-time, without the need for a bulk curtailment signal from power provider 104.

In response to the individual power curtailment signal sent to each of Miners 1-5, the control system for each Miner then automatically reduces power consumption, as shown in Tables 1-5 below.

TABLE 1
Miner 1 Response

| | | | | Starting | Meter | Curtailed |
|---|---|---|---|---|---|---|
| ID # | Client | Date/Time | Setpoint | Load | Data | MWs |
| 1140 | Miner | Jun. 30, 2025 | 0.55 | 7.37 | 7.37 | 0.00 |
| | 1 | 9:16 | | | | |
| 1140 | Miner | Jun. 30, 2025 | 0.55 | 7.37 | 0.61 | 6.76 |
| | 1 | 9:17 | | | | |
| 1140 | Miner | Jun. 30, 2025 | 0.55 | 7.37 | 0.60 | 6.77 |
| | 1 | 9:18 | | | | |
| 1140 | Miner | Jun. 30, 2025 | 0.55 | 7.37 | 0.57 | 6.80 |
| | 1 | 9:19 | | | | |
| 1140 | Miner | Jun. 30, 2025 | 0.55 | 7.37 | 0.56 | 6.81 |
| | 1 | 9:20 | | | | |
| 1140 | Miner | Jun. 30, 2025 | 0.55 | 7.37 | 0.54 | 6.83 |
| | 1 | 9:21 | | | | |

TABLE 2
Miner 2 Response

| | | | | Starting | Meter | Curtailed |
|---|---|---|---|---|---|---|
| ID # | Client | Date/Time | Setpoint | Load | Data | MWs |
| 1140 | Miner | Jun. 30, 2025 | 2.00 | 53.20 | 43.23 | 9.97 |
| | 2 | 9:16 | | | | |
| 1140 | Miner | Jun. 30, 2025 | 2.00 | 53.20 | 17.53 | 35.70 |
| | 2 | 9:17 | | | | |
| 1140 | Miner | Jun. 30, 2025 | 2.00 | 53.20 | 2.14 | 51.10 |
| | 2 | 9:18 | | | | |
| 1140 | Miner | Jun. 30, 2025 | 2.00 | 53.20 | 1.63 | 51.60 |
| | 2 | 9:19 | | | | |
| 1140 | Miner | Jun. 30, 2025 | 2.00 | 53.20 | 1.64 | 51.60 |
| | 2 | 9:20 | | | | |
| 1140 | Miner | Jun. 30, 2025 | 2.00 | 53.20 | 1.68 | 51.50 |
| | 2 | 9:21 | | | | |

TABLE 3
Miner 3 Response

| | | | | Starting | Meter | Curtailed |
|---|---|---|---|---|---|---|
| ID # | Client | Date/Time | Setpoint | Load | Data | MWs |
| 1140 | Miner | Jun. 30, 2025 | 2.00 | 35.88 | 32.36 | 3.52 |
| | 3 | 9:16 | | | | |
| 1140 | Miner | Jun. 30, 2025 | 2.00 | 35.88 | 8.61 | 27.30 |
| | 3 | 9:17 | | | | |
| 1140 | Miner | Jun. 30, 2025 | 2.00 | 35.88 | 4.19 | 31.70 |
| | 3 | 9:18 | | | | |
| 1140 | Miner | Jun. 30, 2025 | 2.00 | 35.88 | 4.13 | 31.80 |
| | 3 | 9:19 | | | | |

TABLE 4
Miner 4 Response

| | | | | Starting | Meter | Curtailed |
|---|---|---|---|---|---|---|
| ID # | Client | Date/Time | Setpoint | Load | Data | MWs |
| 1140 | Miner | Jun. 30, 2025 | 1.00 | 50.07 | 36.38 | 13.70 |
| | 4 | 9:16 | | | | |
| 1140 | Miner | Jun. 30, 2025 | 1.00 | 50.07 | 14.64 | 35.40 |
| | 4 | 9:17 | | | | |
| 1140 | Miner | Jun. 30, 2025 | 1.00 | 50.07 | 2.14 | 47.90 |
| | 4 | 9:18 | | | | |
| 1140 | Miner | Jun. 30, 2025 | 1.00 | 50.07 | 1.92 | 48.20 |
| | 4 | 9:19 | | | | |
| 1140 | Miner | Jun. 30, 2025 | 1.00 | 50.07 | 1.77 | 48.30 |
| | 4 | 9:20 | | | | |
| 1140 | Miner | Jun. 30, 2025 | 1.00 | 50.07 | 1.62 | 48.50 |
| | 4 | 9:21 | | | | |
| 1140 | Miner | Jun. 30, 2025 | 1.00 | 50.07 | 1.49 | 48.60 |
| | 4 | 9:22 | | | | |
| 1140 | Miner | Jun. 30, 2025 | 1.00 | 50.07 | 1.36 | 48.70 |
| | 4 | 9:23 | | | | |
| 1140 | Miner | Jun. 30, 2025 | 1.00 | 50.07 | 1.26 | 48.80 |
| | 4 | 9:24 | | | | |
| 1140 | Miner | Jun. 30, 2025 | 1.00 | 50.07 | 1.16 | 48.90 |
| | 4 | 9:25 | | | | |
| 1140 | Miner | Jun. 30, 2025 | 1.00 | 50.07 | 1.06 | 49.00 |
| | 4 | 9:26 | | | | |
| 1140 | Miner | Jun. 30, 2025 | 1.00 | 50.07 | 1.01 | 49.10 |
| | 4 | 9:27 | | | | |
| 1140 | Miner | Jun. 30, 2025 | 1.00 | 50.07 | 0.95 | 49.10 |
| | 4 | 9:28 | | | | |
| 1140 | Miner | Jun. 30, 2025 | 1.00 | 50.07 | 0.91 | 49.20 |
| | 4 | 9:29 | | | | |
| 1140 | Miner | Jun. 30, 2025 | 1.00 | 50.07 | 0.87 | 49.20 |
| | 4 | 9:30 | | | | |

TABLE 5
Miner 5 Response

| | | | | Starting | Meter | Curtailed |
|---|---|---|---|---|---|---|
| ID # | Client | Date/Time | Setpoint | Load | Data | MWs |
| 1140 | Miner | Jun. 30, 2025 | 2.00 | 50.08 | 50.14 | 0.00 |
| | 5 | 9:16 | | | | |
| 1140 | Miner | Jun. 30, 2025 | 2.00 | 50.08 | 33.40 | 16.70 |
| | 5 | 9:17 | | | | |
| 1140 | Miner | Jun. 30, 2025 | 2.00 | 50.08 | 3.34 | 46.70 |
| | 5 | 9:18 | | | | |
| 1140 | Miner | Jun. 30, 2025 | 2.00 | 50.08 | 2.71 | 47.40 |
| | 5 | 9:19 | | | | |
| 1140 | Miner | Jun. 30, 2025 | 2.00 | 50.08 | 2.72 | 47.40 |
| | 5 | 9:20 | | | | |
| 1140 | Miner | Jun. 30, 2025 | 2.00 | 50.08 | 2.74 | 47.30 |
| | 5 | 9:21 | | | | |
| 1140 | Miner | Jun. 30, 2025 | 2.00 | 50.08 | 2.75 | 47.30 |
| | 5 | 9:22 | | | | |
| 1140 | Miner | Jun. 30, 2025 | 2.00 | 50.08 | 2.75 | 47.30 |
| | 5 | 9:23 | | | | |
| 1140 | Miner | Jun. 30, 2025 | 2.00 | 50.08 | 2.77 | 47.30 |
| | 5 | 9:24 | | | | |
| 1140 | Miner | Jun. 30, 2025 | 2.00 | 50.08 | 2.80 | 47.30 |
| | 5 | 9:25 | | | | |
| 1140 | Miner | Jun. 30, 2025 | 2.00 | 50.08 | 2.81 | 47.30 |
| | 5 | 9:26 | | | | |
| 1140 | Miner | Jun. 30, 2025 | 2.00 | 50.08 | 2.84 | 47.20 |
| | 5 | 9:27 | | | | |
| 1140 | Miner | Jun. 30, 2025 | 2.00 | 50.08 | 2.87 | 47.20 |
| | 5 | 9:28 | | | | |
| 1140 | Miner | Jun. 30, 2025 | 2.00 | 50.08 | 2.88 | 47.20 |
| | 5 | 9:29 | | | | |

As shown in Tables 1-5, and with reference to FIG. 5, each of Miners 1-5 had a different compliance response to its individual power curtailment setpoint, primarily due to each Miner's specific control system programming and/or the specific capabilities of the one or more computer systems within that particular data center. The cumulative curtailment response for Miners 1-5 is shown below in Table 6.

TABLE 6
Cumulative Curtailment Response

| | | | Starting | Meter | Curtailed |
|---|---|---|---|---|---|
| ID # | Date/Time | Setpoint | Load | Data | MWs |
| 1140 | Jun. 30, 2025 | 7.55 | 196.60 | 196.60 | 0.00 |
| | 9:15 | | | | |
| 1140 | Jun. 30, 2025 | 7.55 | 196.60 | 169.48 | 27.12 |
| | 9:16 | | | | |
| 1140 | Jun. 30, 2025 | 7.55 | 196.60 | 74.79 | 121.81 |
| | 9:17 | | | | |
| 1140 | Jun. 30, 2025 | 7.55 | 196.60 | 12.41 | 184.19 |
| | 9:18 | | | | |
| 1140 | Jun. 30, 2025 | 7.55 | 196.60 | 10.96 | 185.64 |
| | 9:19 | | | | |
| 1140 | Jun. 30, 2025 | 7.55 | 196.60 | 10.82 | 185.78 |
| | 9:20 | | | | |
| 1140 | Jun. 30, 2025 | 7.55 | 196.60 | 10.71 | 185.89 |
| | 9:21 | | | | |
| 1140 | Jun. 30, 2025 | 7.55 | 196.60 | 10.59 | 186.01 |
| | 9:22 | | | | |
| 1140 | Jun. 30, 2025 | 7.55 | 196.60 | 10.46 | 186.14 |
| | 9:23 | | | | |
| 1140 | Jun. 30, 2025 | 7.55 | 196.60 | 10.38 | 186.22 |
| | 9:24 | | | | |
| 1140 | Jun. 30, 2025 | 7.55 | 196.60 | 10.30 | 186.30 |
| | 9:25 | | | | |
| 1140 | Jun. 30, 2025 | 7.55 | 196.60 | 10.22 | 186.38 |
| | 9:26 | | | | |
| 1140 | Jun. 30, 2025 | 7.55 | 196.60 | 10.21 | 186.39 |
| | 9:27 | | | | |
| 1140 | Jun. 30, 2025 | 7.55 | 196.60 | 10.18 | 186.42 |
| | 9:28 | | | | |
| 1140 | Jun. 30, 2025 | 7.55 | 196.60 | 10.15 | 186.44 |
| | 9:29 | | | | |
| 1140 | Jun. 30, 2025 | 7.55 | 196.60 | 10.12 | 186.48 |
| | 9:30 | | | | |

A “bulk” end curtailment signal 502 is then received from power provider 104 at 9:30 am, requesting that the current MW load of 10.11 MWs for Miners 1-5 be throttled up to 223.00 MW:

| ID # | Event Received | Curtail | Set Point | Starting Load |
|---|---|---|---|---|
| 1141 | Jun. 30, 2025 9:30 | NO | 223.00 | 10.11 |

Computing platform 100 then sends an end curtailment signal 502 to each of Miners 1-5, who then throttle up to full power consumption as shown graphically in FIG. 5. As with the curtailment signal 500, the specific individual curtailment responses for each of the Miners varied for the same reasons. Computer platform 100 also preferably sends out operational alerts to each of Miners 1-5 and power provider 104 throughout the curtailment event, providing data relating to curtailment status, such as, for example, real-time power pricing, curtailment and end curtailment setpoints, and real-time power load data for each of Miners 1-5.

In the illustrative embodiment of FIG. 5, the curtailment “event” lasted approximately 15 minutes, and enabled power provider 104 to exercise its rights under the applicable PPAs to sell power at a higher price to grid operator 102. In particular, Miners 1-5 were able to successfully curtail approximately 122 MWs within the first two minutes, and 184 MWs within the first three minutes of receiving the power curtailment setpoint 500. As such, the real-time reaction to power pricing enabled by the present invention results in the ability to maximize usage of PPA curtailment provisions for non-critical data centers. Specifically, the present invention enables the successful monetization of unscheduled curtailment events as small as 5 minutes or less in duration, 24 hours a day, 7 days a week. The unscheduled nature of the curtailments is completely infeasible based solely on prior art human intervention techniques that require both prior notice and human coordination/scheduling to execute.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings therein. It is therefore evident that the particular embodiments disclosed above may be altered or modified and all such variations are considered within the scope and sprit of the present invention.

What is claimed is:

1. A system, comprising:
a power grid operator;
a power provider;
one or more non-critical data centers configured to receive power from the power provider; and
a computing platform in data communication with at least the power provider and the one or more non-critical data centers, wherein the computing platform is configured to:
(1) receive real-time power consumption data from the one or more non-critical data centers;
(2) receive real-time power pricing data from the power grid operator or the power provider;
(3) send a curtailment signal to each of the one or more non-critical data centers; and
(4) send an end curtailment signal to each of the one or more non-critical data centers.

2. The system of claim 1, wherein the curtailment signal is automatically sent to each of the one or more non-critical data centers when the real-time power price is above a predetermined curtailment price.

3. The system of claim 1, wherein the curtailment signal is automatically sent to each of the one or more non-critical data centers upon receipt by the computing platform of a bulk curtailment signal from the power provider.

4. The system of claim 1, wherein the end curtailment signal is automatically sent to each of the one or more non-critical data centers upon receipt by the computing platform of a bulk end curtailment signal from the power provider.

5. The system of claim 1, wherein the end curtailment signal is automatically sent to each of the one or more non-critical data centers when the real-time power price remains below a predetermined end curtailment price for a predetermined period of time.

6. The system of claim 1, wherein the one or more non-critical data centers comprises at least one cryptocurrency mining data center.

7. The system of claim 1, wherein the one or more non-critical data centers comprises at least one artificial intelligence data center.

8. The system of claim 1, wherein the power provider and at least one non-critical data center has a purchase power agreement (PPA) comprising a fixed contractual power price, wherein the PPA allows the power provider to curtail power to the at least one non-critical data center.

9. The system of claim 1, wherein the power provider and at least one non-critical data center has a purchase power agreement (PPA) comprising a variable power price, wherein the PPA allows the at least one data center to voluntarily curtail power.

10. The system of claim 1, wherein the computing platform comprises a primary database that receives external data and API data, and a time series database in data communication with the primary database that enables web-based access by registered users to user-specific timestamped API data.

11. The system of claim 10, wherein the web-based access comprises a dashboard.

12. The system of claim 10, wherein the web-based access comprises historical power consumption data.

13. The system of claim 10, wherein the registered users are selected from administrators of the at least one non-critical data centers, administrators of the computing platform, administrators of the power provider, administrators of the grid operator, energy traders, and payment processors.

14. The system of claim 1, wherein the computing platform is further configured to provide alerts to one or more of the grid operator, the power provider, and the one or more non-critical data centers when the real-time power price is above a predetermined curtailment price.

15. The system of claim 1, wherein the computing platform is further configured to provide alerts to one or more of the grid operator, the power provider, and the one or more non-critical data centers when a curtailment signal is sent to the one or more non-critical data centers.

16. The system of claim 1, wherein the computing platform is further configured to provide alerts to one or more of the grid operator, the power provider, and the one or more non-critical data centers when an end curtailment signal is sent to the one or more non-critical data centers.

17. The system of claim 1, wherein the computing platform is further configured to provide invoicing data to the power provider.

18. The system of claim 1, wherein the computing platform is further configured to provide invoicing data to the one or more non-critical data centers.

19. The system of claim 1, wherein the computing platform is further configured to provide energy consumption invoicing to at least one of the non-critical data centers and a third-party payment service provider via secure API connectivity.

20. The system of claim 19, wherein the energy consumption invoicing is daily.
